(19) United States
(12) Patent Application Publication
(10) Pub. No.: US 2012/0170886 A1
(43) Pub. Date: Jul. 5, 2012

(54) OPTICAL FIBER COMMUNICATION APPARATUS

(75) Inventors: TAI-CHERNG YU, Tu-Cheng (TW); I-THUN LIN, Tu-Cheng (TW)

(73) Assignee: HON HAI PRECISION INDUSTRY CO., LTD., Tu-Cheng (TW)

(21) Appl. No.: 13/069,395

(22) Filed: Mar. 23, 2011

(30) Foreign Application Priority Data
Dec. 30, 2010 (TW) 99147063

(51) Int. Cl. G02B 6/42

(52) U.S. Cl. 385/14

(57) ABSTRACT

An optical fiber communication apparatus includes a laser diode, a light directing member, and an optical fiber. The laser diode is configured for emitting a laser beam along a first direction. The light directing member includes a converging lens portion and a reflecting surface. The converging lens portion is optically aligned with the laser diode and configured for converging the laser beam. The reflecting surface is obliquely oriented relative to a second direction and configured for reflecting the converged laser beam toward. The second direction is perpendicular to the first direction. The optical fiber is oriented along the second direction and configured for receiving the reflected converged laser beam.

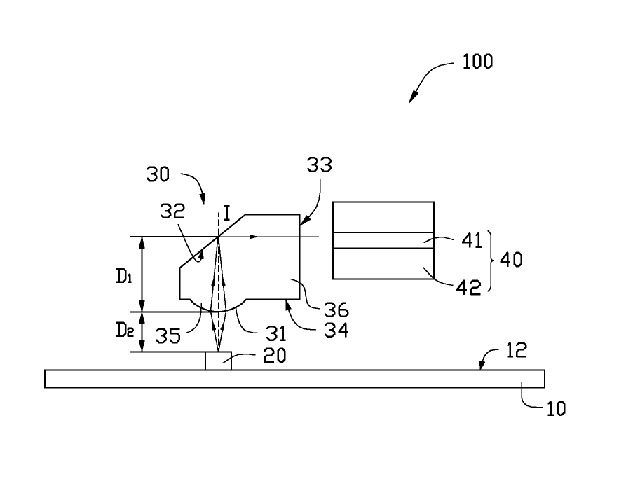

### BACKGROUND

1. Technical Field

The present disclosure relates to communication technology, especially relating to a communication apparatus including an optical fiber.

2. Description of Related Art

Optical communication apparatus often use LED(s) as a light source. The light emitted by the LED is directed to one or more optical fibers. If an optical fiber is located along the direction of the light propagation, the optical communication apparatus will be bulky. If the optical fiber is bent to receive the light, it may be compact but bend loss is added to the communication.

What is needed, therefore, is a compact optical fiber communication apparatus with low bend loss.

### BRIEF DESCRIPTION OF THE DRAWINGS

Many aspects of the present optical fiber communication apparatus can be better understood with reference to the following drawings. The components in the drawings are not necessarily drawn to scale, the emphasis instead being placed upon clearly illustrating the principles of the present optical fiber communication apparatus. Moreover, in the drawings, like reference numerals designate corresponding parts throughout the views.

The drawing is a schematic general view of an optical fiber communication apparatus in accordance with an exemplary embodiment.

### DETAILED DESCRIPTION

Referring to the drawing, an optical fiber communication apparatus 100 includes a printed circuit board (PCB) 10, a laser diode 20, a light directing member 30, and an optical fiber 40. In this embodiment, the laser diode 20 is a vertical cavity surface emitting laser (VCSEL). The laser diode 20 is mounted on the PCB 10.

The PCB 10 includes an outer surface 12. The laser diode 20 is mounted on the outer surface 12. A laser beam emitted from the laser diode 20 is substantially being along a first direction, in this embodiment, that is, perpendicular to the outer surface 12. The laser beam emitted by the laser diode 20 is also substantially perpendicular to an emitting surface of the laser diode 20.

The light directing member 30 is a light guide block that includes a converging lens portion 31, an inner reflecting surface 32, and a light emitting surface 33. The converging lens portion 31 faces the PCB 10. The converging lens portion 31 is optically aligned with the laser diode 20 and configured for converging the laser beam. The converging lens portion 31 includes a spherical or non-spherical surface that has a main optical axis I. The converging lens portion 31 opposes the laser diode 20.

The inner reflecting surface 32 is located inside the light directing member 30 and obliquely oriented relative to a second direction and configured for reflecting the converged laser beam toward. The second direction is perpendicular to the first direction, and also perpendicular to the light emitting surface 33. The inner reflecting surface 32 has an acute angle relative to the main optical axis I. The acute angle is 30°, or 50° according to need. In this embodiment, the acute angle is 45°, therefore the reflection loss will be lower than the condition using other acute angle. The focal point of the converging lens portion 31 is located at or in the vicinity of the inner reflecting surface 32. The light emitting surface 33 is a flat surface parallel with the main optical axis I.

The light directing member 30 further has a flat surface 34 perpendicular to the main optical axis I. The flat surface 34 surrounds the converging lens portion 31, and the converging lens portion 31 protrudes from the flat surface 34.

The laser diode 20 has a small laser emitting angle below 20 degrees, and the laser is substantially parallel to the main optical axis I. The laser input the light directing member 30 converges at the focal point of the converging lens portion 31. The spot size of the laser light is less than the original beam diameter of the laser. The laser then is reflected by the inner reflecting surface 32 to the light emitting surface 33, and emits from the light emitting surface 33. An output laser light is substantially perpendicular to the light emitting surface 33.

The optical fiber 40 is oriented along the second direction configured for receiving the reflected converged laser beam. The optical fiber 40 includes a transparent core 41 surrounded by a transparent cladding material layer 42 with a lower index of refraction than the core. The optical fiber 40 is substantially parallel with the outer surface 12. The optical fiber 40 faces the light emitting surface 33 and receives as much of the output laser light as possible. It is unnecessary to bend the optical fiber 40 due to the light directing member 30, thus lowering the bend loss.

To lower the insertion loss due to the light directing member 30, the optical fiber communication apparatus may fulfill anyone or all of conditions below:

(1) a laser emitting area is smaller than 0.02 mm²;

(2) a laser emitting angle is less than 16 degrees;

(3) if a distance between the converging lens portion 31 and the inner reflecting surface 32 along the main optical axis I, that is, a first optical path length, is D1, a distance of a gap between the converging lens portion 31 and the laser light source 20 is D2, it is required that D2 is longer than D1.

When anyone or all of these conditions are fulfilled, the light directing member 30 may be designed freely, and the insertion loss may be below −0.5 dB.

According to experiments, even though the laser emitting angle angel is about 16 degrees, the insertion loss of this optical communication apparatus 100 may be below −0.5 dB, see table 1.

TABLE 1

| Laser Emitting | Insertion |
|---|---|
| Angle(degree) | loss (dB) |
| 0 | −0.468736 |
| 4 | −0.468494 |
| 7 | −0.468011 |
| 10 | −0.467285 |
| 14 | −0.465738 |
| 16 | −0.464771 |
| 20 | −0.572828 |
| 23 | −1.563745 |
| 25 | −2.242294 |

The table 1 shows that when the laser emitting angle is in the range from 11 degrees to 16 degrees, the insertion loss is below −0.5 dB. According to table 1, when the laser emitting angle is in the range from 5 to 10 degrees, the variance of the insertion loss is smaller than 0.1 dB, therefore, the laser emitting angle is preferred to be in the range from 5 to 10 degrees.

To lower the insertion loss, the light directing member 30 is as thin as possible. However, the laser diode 20 has a predetermined laser emitting area and the diameter of the optical fiber 40 is small, therefore the first optical path length D1 is short but still longer than D2 to converge the laser as much as possible.

In the other side, if D2 is shorter, the volume of the optical communication apparatus will be smaller. However, the diameter of the optical fiber 40 and a distance between the optical fiber 40 and the outer surface 12 should be considered. According to experiments, when a sum of D1 and D2 is not greater than 0.3 .mm, and D2 is equal to or longer than 0.1 mm, the insertion loss is lowered.

The light directing member 30 is configured to redirect the direction of the laser into the optical fiber 40 located along the propagation of the output laser, thus a compact optical communication apparatus with low bend loss and insertion loss is obtained.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. An optical fiber communication apparatus, comprising:
a laser diode for emitting a laser beam along a first direction;
a light directing member comprising a converging lens portion and a reflecting surface, the converging lens portion optically aligned with the laser diode and configured for converging the laser beam, the reflecting surface obliquely oriented relative to a second direction and configured for reflecting the converged laser beam toward, the second direction perpendicular to the first direction; and
an optical fiber oriented along the second direction configured for receiving the reflected converged laser beam.

2. The optical fiber communication apparatus according to the claim 1, wherein the converging lens portion has an aspherical surface.

3. The optical fiber communication apparatus according to the claim 2, wherein a first optical path length D1 between the aspherical surface and the reflecting surface of the light directing member is greater than a second optical path length D2 between the aspherical surface and the laser diode.

4. The optical fiber communication apparatus according to claim 3, wherein a sum of D1 and D2 is less than 0.3 mm, and D2 is equal to or greater than 0.1 mm.

5. The optical fiber communication apparatus according to the claim 1, wherein the light directing member is a light guide block having the converging lens portion, the light reflecting surface, and a light emitting surface perpendicular to the second direction.

6. The optical fiber communication apparatus according to the claim 5, wherein the laser diode is a VCSEL having an emitting area of less than 0.02 mm².

7. The optical fiber communication apparatus according to the claim 1, wherein the laser diode has a laser emitting angle of equal to or less than 16 degrees.

8. The optical fiber communication apparatus according to claim 7, wherein the laser emitting angle is in the range from 5 to 10 degrees.

9. The optical fiber communication apparatus according to claim 1, further comprising a PCB, the laser diode mounted on the PCB.

10. The optical fiber communication apparatus according to claim 1, wherein the converging lens portion faces the PCB.

11. The optical fiber communication apparatus according to claim 1, wherein the reflecting surface is oriented at 45 degrees relative to the first direction and second direction.

12. The optical fiber communication apparatus according to claim 1, wherein a focal point of the converging lens portion is located on the reflecting surface.
